(19) United States
(12) Patent Application Publication
(10) Pub. No.: US 2016/0129375 A1
(43) Pub. Date: May 12, 2016

(54) SPOOL VALVE FOR DUAL FUEL BASE OPERATION FILTERS

(71) Applicant: Parker-Hannifin Corporation, Cleveland, OH (US)

(72) Inventor: Richard Bruce Jones, Germantown, TN (US)

(21) Appl. No.: 14/851,463

(22) Filed: Sep. 11, 2015

Related U.S. Application Data
(60) Provisional application No. 62/076,720, filed on Nov. 7, 2014.

(51) Int. Cl. B01D 29/52; F16K 11/06; B01D 29/90

(52) U.S. Cl. CPC B01D 29/52; B01D 29/90; F16K 11/06

(57) ABSTRACT

A spool valve includes a cylindrical spool body defining porting for control of fluid flow through the spool body, the spool body having pockets on an outer surface and sealing inserts received within the pockets. The sealing inserts and the porting are configured to control fluid flow through the spool valve based on an alignment of the sealing inserts and the porting corresponding to rotational positioning of the spool valve within a valve housing. The spool valve may be incorporated into a filter head of a filter assembly including a first filter and a second filter. Based on the rotational position of the spool valve, the spool valve is configured to block fluid flow to and from one of the filters and permit fluid flow to and from the other of the filters, the sealing inserts providing a seal against the valve housing to prevent leakage from the blocked filter.

### RELATED APPLICATIONS

This application claims the benefit of U.S. Provisional Application No. 62/076,720 filed Nov. 7, 2014, which is incorporated herein by reference.

### FIELD OF INVENTION

The present invention relates generally to fluid filter assemblies, and more particularly to spool valve assemblies that control fluid flow through dual fuel base operation filters.

### BACKGROUND OF THE INVENTION

A variety of applications employ fluid filter assemblies. Such applications include, for example, hydraulic systems, fuel delivery systems, coolant systems, and engine lubrication systems. Filter assemblies may be used to filter any type of fluid, such as, for example, gasoline, diesel fuel, lubricating oil, water, coolant fluid, and others.

Conventional fluid filter assemblies may include a filter media, such as a sheet of fibrous filter material folded to form a plurality of parallel pleats or folds. The side edges of the sheet are brought together so that the sheet has a cylindrical configuration, with the pleats of the sheet extending in the axial or longitudinal direction. The side edges of the sheet are then joined together, such as with adhesive, stitching or other means, to retain the filter material in the cylindrical form. The media can be imparted with resin, and/or an outer or inner wire mesh sheet, weave, or mesh cage for enhanced durability, if warranted or desirable. The reinforcement provided by such structures prevents the pleats from bunching, prevents media migration, and maintains media efficacy.

As the filter is used, contaminants may be build up within the filter media, which impedes or restricts the fluid flow. Accordingly, the filter media periodically must be replaced. It is desirable, however, that reduced performance of a single filter element or media not impede the overall performance of the system. Accordingly, for redundancy, it is common for multiple filter components to be incorporated into a single filter assembly, so that system operation may be maintained even with reduced effectiveness of a given filter component. A simple example of a redundant filter assembly is a dual fuel base operation (DFBO) filter assembly, which employs two filters that may operate either in combination or individually.

In a DFBO filter assembly, fluid flow to the two filters typically is controlled by a spool valve. The spool valve rotates within a bore, and has porting that is configured to control fluid flow based on the rotational position of the spool valve. The spool valve may be positioned to permit flow to both of the filter components, or to only one or the other of the two filter components. The ability to permit flow to only one or the other of the two filter components may be particularly useful. It has been contemplated that in the event the filter media of a first filter component needs to be replaced, flow to the first filter component may be blocked. Simultaneously, fluid flow still may be permitted to a second filter component. In this manner, the system operation may be maintained while the filter media of the first filter component is replaced.

However, effective operation during filter replacement requires that the blocked off flow to the filter component undergoing replacement be fully sealed. A conventional configuration merely has utilized a tight tolerance fit of the spool valve within the bore in which the spool valve rotates. The tight tolerance fit had been intended to preclude the flow of fluid to either the first or second filter component without leakage, while the other of the two filter components remains in operation. Due to pressure differentials that occur within the system, however, the tight tolerance has proven to be insufficient to prevent leakage. Conventional spool valve configurations thus have been prone to leakage during filter replacement of one of the filter components, which undermines performance of the system, and results in additional lost time and expense associated with any necessary clean-up. The alternative is to shut down the entire system for replacement of a single filter media, which also is undesirable as resulting in unwanted downtime.

### SUMMARY OF THE INVENTION

The present invention provides an enhanced spool valve for a filter assembly having multiple filter components, such as a DFBO filter assembly. The spool valve assembly blocks flow to one of the fluid components to permit a filter replacement for such filter component, while another filter component remains in operation without leakage of fluid from the blocked filter component.

In exemplary embodiments, a spool valve body is milled to include two pockets, each pocket being configured to receive a sealing insert. A first sealing insert is provided to seal an input fluid pathway to a given filter component, and a second sealing insert is provided to seal an output fluid pathway from the same given filter component. Each sealing insert has an o-ring cushion that applies pressure on an inner diameter of the ports in the filter housing or head that lead to the filter component. The sealing inserts also provide a secondary sealing function against the inner diameter of the bore in which the spool valve rotates.

An aspect of the invention, therefore, is a spool valve. In exemplary embodiments, the spool valve includes a cylindrical spool body defining porting for control of fluid flow through the spool body, the spool body having pockets on an outer surface and sealing inserts received within the pockets. The sealing inserts and the porting are configured to control fluid flow through the spool valve based on an alignment of the sealing inserts and the porting corresponding to rotational positioning of the spool valve within a valve housing. The spool valve may be incorporated into a filter head of a filter assembly including a first filter and a second filter. Based on the rotational position of the spool valve, the spool valve is configured to block fluid flow to and from one of the filters and permit fluid flow to and from the other of the filters, the sealing inserts providing a seal against the valve housing to prevent leakage of fluid from the blocked filter.

In exemplary embodiments of the spool valve, the spool body may include a first pocket and a second pocket formed on the outer surface of the spool body, and a first sealing insert received in the first pocket and a second sealing insert received in the second pocket. Each sealing insert may include a base that is positioned against the pocket, and a raised cushion that extends perpendicularly from the base. A shape of the base of the sealing insert may correspond to a shape of the pocket. The cushion may have a rounded cross-section and extend from the base to different heights along the cross-section, including convex portions and concave portions that alternate along the cross-section of the cushion. Each sealing insert further may have an annular groove and an o-ring received within the annular groove, wherein the o-ring is compressible to energize the sealing insert to provide a seal against porting in a valve housing.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a side view of an exemplary filter assembly in accordance with embodiments of the present invention.

FIG. 2 is a drawing depicting a top view of the exemplary filter assembly of FIG. 1.

FIG. 3 is a drawing depicting an isometric and exploded view of an exemplary filter head with spool valve that may be employed in the filter assembly of FIGS. 1 and 2.

FIG. 4 is a drawing depicting an isometric view of an exemplary spool valve in accordance with embodiments of the present invention.

FIG. 5 is a drawing depicting an isometric view of an exemplary spool valve body of the spool valve of FIG. 4, in accordance with embodiments of the present invention.

FIG. 6 is a drawing depicting an isometric top-side view of an exemplary sealing insert of the spool valve of FIG. 4 in accordance with embodiments of the present invention.

FIG. 7 is a drawing depicting an isometric bottom-side view of the sealing insert.

FIG. 8 is a drawing depicting a side view of the exemplary sealing insert from a convex side.

FIG. 9 is a drawing depicting a side view of the exemplary sealing insert from a concave side.

### DETAILED DESCRIPTION

Embodiments of the present invention will now be described with reference to the drawings, wherein like reference numerals are used to refer to like elements throughout. It will be understood that the figures are not necessarily to scale.

As further detailed below, an aspect of the invention is a spool valve. In exemplary embodiments, the spool valve includes a cylindrical spool body defining porting for control of fluid flow through the spool body, the spool body having pockets on an outer surface and sealing inserts received within the pockets. The sealing inserts and the porting are configured to control fluid flow through the spool valve based on an alignment of the sealing inserts and the porting corresponding to rotational positioning of the spool valve within a valve housing. The spool valve may be incorporated into a filter head of a filter assembly including a first filter and a second filter. Based on the rotational position of the spool valve, the spool valve is configured to block fluid flow to and from one of the filters and permit fluid flow to and from the other of the filters, the sealing inserts providing a seal against the valve housing to prevent leakage of fluid from the blocked filter.

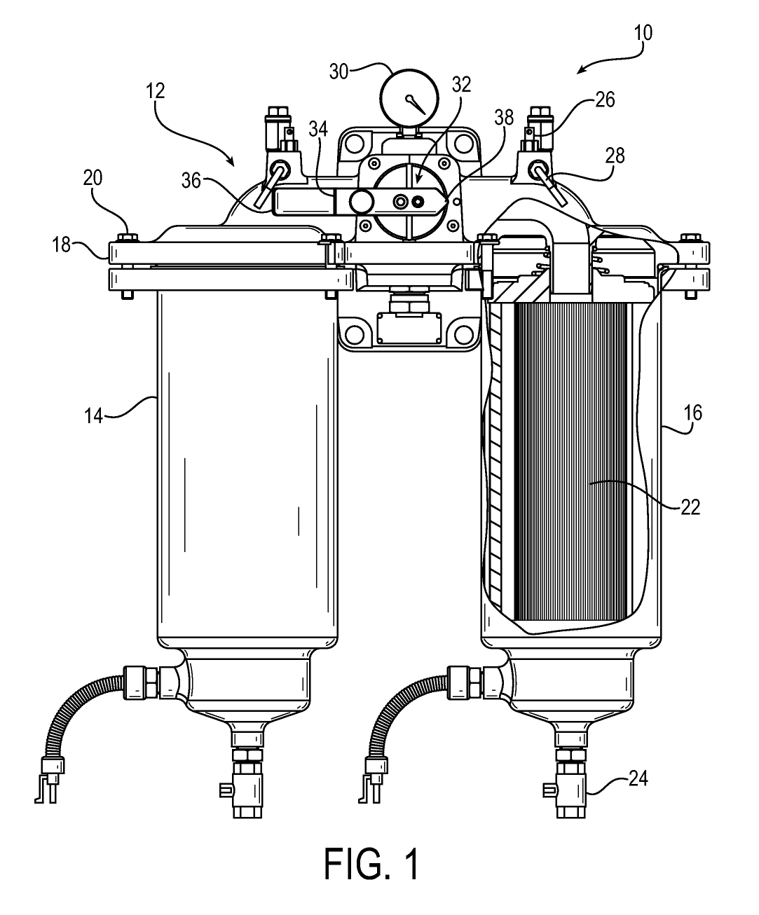

FIG. 1 is a drawing depicting a side view of an exemplary filter assembly 10 in accordance with embodiments of the present invention. The example of FIG. 1 is a DFBO filter assembly, which includes two filter components and a spool valve that controls the flow of fluid as between the two filter components. It will be appreciated, however, that the invention is not limited to the specific configuration of FIG. 1, but principles of the invention may be employed in any filter assembly that uses multiple filter components. In some systems as are known in the art, filter assemblies may permit modular expansion by the addition of any number of filter components, and additional spool valves commensurately may be employed to control fluid flow as between any adjacent filter components.

The filter assembly 10 includes a filter head 12 that acts as a housing for supporting a first filter component 14 and a second filter component 16. As further detailed below, the filter head defines porting and fluid pathways associated with the spool valve of the present invention. The principles of the invention, however, may be employed in any suitable spool valve systems for controlling fluid flow to multiple pathways, other than in connection with filter assemblies. The filter head 12, therefore, also may be referred to more generally as a valve head.

In embodiments in which the valve head is employed as a filter head for a filter assembly, the filter components may be secured to the filter head 12 via a clamp 18 that fixes the filter components to the head using any suitable fastening elements 20. The second filter component 16 is depicted in cross-section to illustrate the filter media 22 that is internal within the second filter component 16. A comparable filter media is provided internally within first filter component 14. Each filter component may include a drain valve 24 that may be used to drain the filter components for maintenance, and any other suitable tubing or other fluid connections as may be suitable for any particular application. Each filter component may include a venting valve 26 and air exhaust 28 that an operator may employ for regulating pressure within the filter assembly 10. A gauge (or gauges) 30 further may be provided to indicate system properties to an operator, such as pressure or fluid flow rate.

A spool valve 32 may be employed to control fluid flow as between the first filter component 14 and the second filter component 16. Control of the fluid is based on a rotational position of the spool valve 32 within a bore defined by the filter head 12. Generally, during operation of the system, the spool valve 32 is configured to operate as a three-way or three-position valve. A first rotational position corresponds to both filter components being in operation; a second rotational position corresponds to the first filter component 14 receiving flow and being in operation, and the second filter component 16 being blocked from fluid flow and isolated from the remainder of the system; and a third rotational position corresponds to the second filter component 16 receiving flow and being in operation, and the first filter component 14 being blocked from fluid flow and isolated from the remainder of the system.

The rotational position of the spool valve 32 may be set by an operator using a spool handle 34. A first end 36 of the spool handle 34 may constitute a gripping portion that an operator may employ to rotate the spool handle, which in turn rotates the spool valve 32. A second end 38 of the spool handle 34 may constitute a spool locator that provides a visual indication to the operator of the rotational position of the spool valve 32. In the example of FIG. 1, the spool locator 38 is pointing to the second filter component, which actually corresponds to the third position of the spool valve referenced above (i.e., the second filter component 16 being in operation and the first filter component 14 being blocked and isolated). An operator may rotate the spool valve using the spool handle 90° clockwise (spool indicator pointing down or away from the gauge) to move the spool valve 32 to the first position referenced above (i.e., both filter components being in operation). An operator may rotate the spool valve using the spool handle 180° (spool indicator pointing toward the first filter component) to move the spool valve 32 to the second position referenced above (i.e., the first filter component 14 being in operation and the second filter component 16 being blocked and isolated).

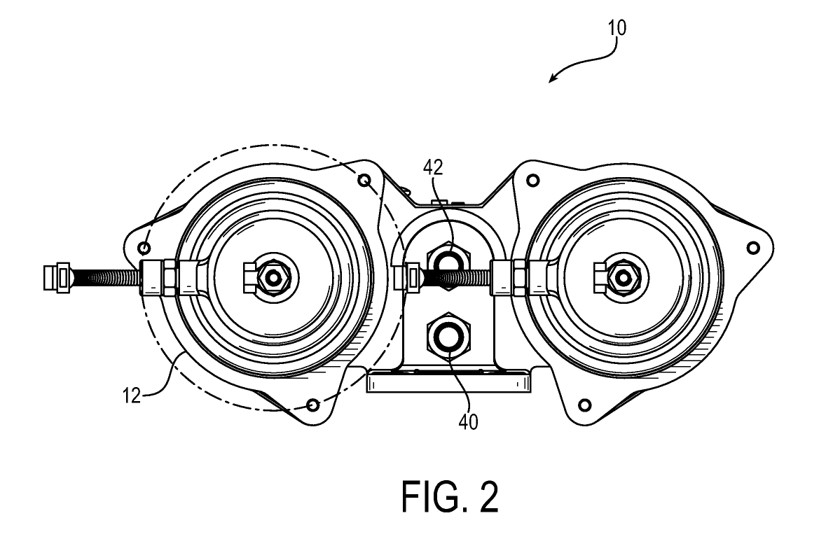

FIG. 2 is a drawing depicting a top view of the exemplary filter assembly 10 of FIG. 1. Accordingly, FIG. 2 principally depicts the filter head 12, and thus shows the main porting for fluid flow into and out from the filter assembly 10. In particular, the filter head 12 includes a main inlet port 40 for a main inlet flow of pre-filtered fluid into the filter assembly 10, and a main outlet port 42 for a main outlet flow of filtered fluid out from the filter assembly 10.

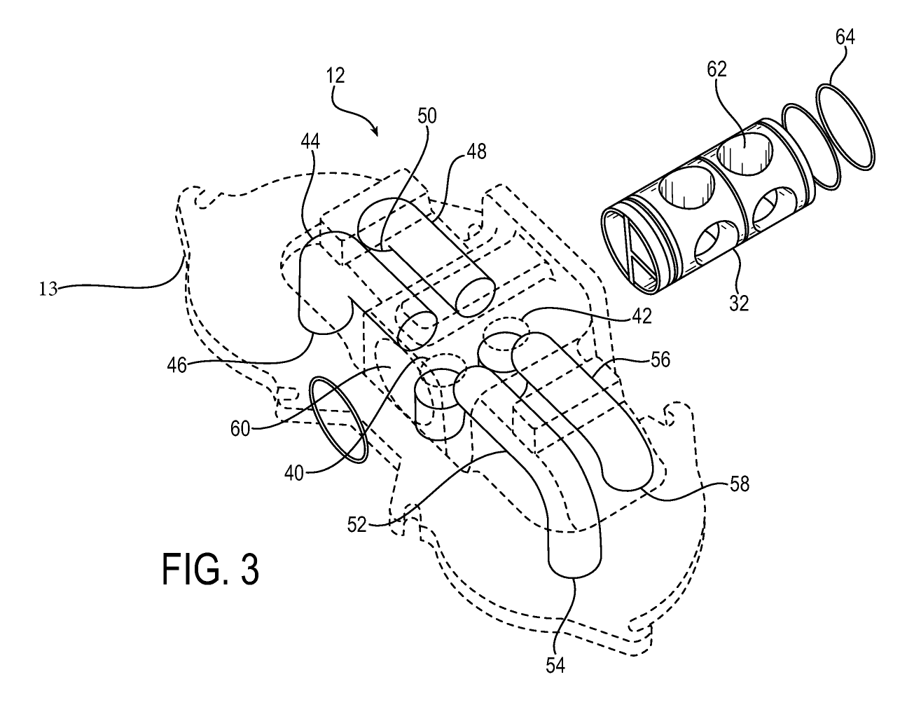

FIG. 3 is a drawing depicting an isometric and exploded view on the exemplary filter head 12 with spool valve 32 that may be employed in the filter assembly of FIGS. 1 and 2. FIG. 3 illustrates additional fluid pathways and porting through the filter head 12. In fluid communication with the main inlet port 40, a first inlet path 44 ends in a first filter inlet 46, which provides a first inlet flow into the first filter component 14. In fluid communication with the main outlet port 42, a first outlet path 48 ends in a first filter outlet 50, which provides a first outlet flow out from the first filter component 14. In similar fashion, in fluid communication with the main inlet port 40, a second inlet path 52 ends in a second filter inlet 54, which provides a second inlet flow into the second filter component 16. In fluid communication with the main outlet port 42, a second outlet path 56 ends in a second filter outlet 58, which provides a second outlet flow out from the second filter component 16.

The filter head 12 comprises a housing 13 that defines a bore 60 that is configured to receive the spool valve 32. The spool valve 32 is positioned and rotatable within a bore 60. The spool valve 32 further includes porting 62, which is described in more detail below and generally controls the flow of fluid to and from the filter components based on the rotational position of the spool valve within the bore. O-rings 64 operate as sealing elements as between an outer diameter of the spool valve and an inner diameter of the bore.

In exemplary embodiments of the spool valve 32, the spool body may include a first pocket and a second pocket formed on the outer surface of the spool body, and a first sealing insert received in the first pocket and a second sealing insert received in the second pocket. Each sealing insert may include a base that is positioned against the pocket, and a raised cushion that extends perpendicularly from the base. A shape of the base of the sealing insert may correspond to a shape of the pocket. The cushion may have a rounded cross-section and extend from the base to different heights along the cross-section, including convex portions and concave portions that alternate along the cross-section of the cushion. Each sealing insert further may have an annular groove and an o-ring received within the annular groove, wherein the o-ring is compressible to energize the sealing insert to provide a seal against porting in a valve housing.

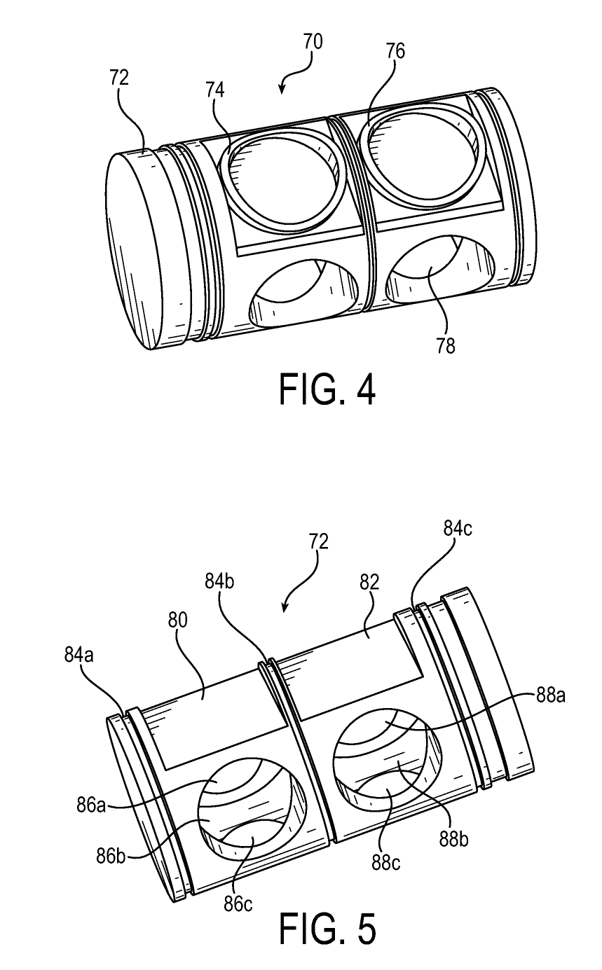

FIG. 4 is a drawing depicting an isometric view of an exemplary spool valve 70 in accordance with embodiments of the present invention. The spool valve 70 may be used in the filter assembly 10 described above as an embodiment of the spool valve 32, specifically by being received in and rotating within the bore 60 (see FIG. 3). The spool valve 70 includes a generally cylindrical spool body 72, a first sealing insert 74, and second sealing insert 76, and porting 78.

FIG. 5 is a drawing depicting an isometric view of the exemplary spool valve body 72 of the spool valve of FIG. 4 in accordance with embodiments of the present invention. The spool body 72 may be made of any suitable rigid material, such as any suitable rigid plastic or metal, as are known in the art as being used for spool valves. The spool body 72 includes a first pocket 80 and a second pocket 82, which are milled into the spool body. The first pocket 80 is configured to receive the first sealing insert 74, and the second pocket 82 is configured to receive the second sealing insert 76. In exemplary embodiments, bases of the two sealing inserts, and commensurately the two pockets, have like or corresponding shapes. For example, the pockets and the bases of the sealing inserts may be square shaped, although any suitable shape may be employed. The valve body 72 further may include circumferential grooves 84a, 84b, and 84c, each of which is configured to receive one of the o-rings 64 identified in FIG. 3.

FIG. 5 also illustrates the details of the porting in the spool body 72 referenced more generally above. The spool body includes a plurality of inlet control ports 86a, 86b, and 86c (ports 86a and 86c being partially visible). The inlet control ports are configured to control the inlet flow of fluid from the main inlet port 40 of the filter head 12 into the two filter components. The spool body further includes outlet control ports 88a, 88b, and 88c (ports 88a and 88c being partially visible). The outlet control ports are configured to control the outlet flow of fluid from the two filter components out through the main outlet port 42 of the filter head 12.

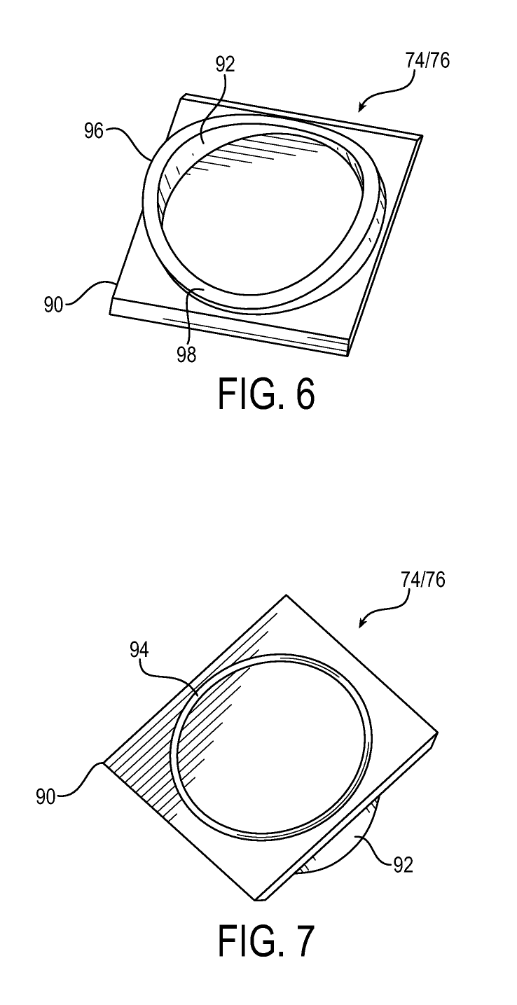

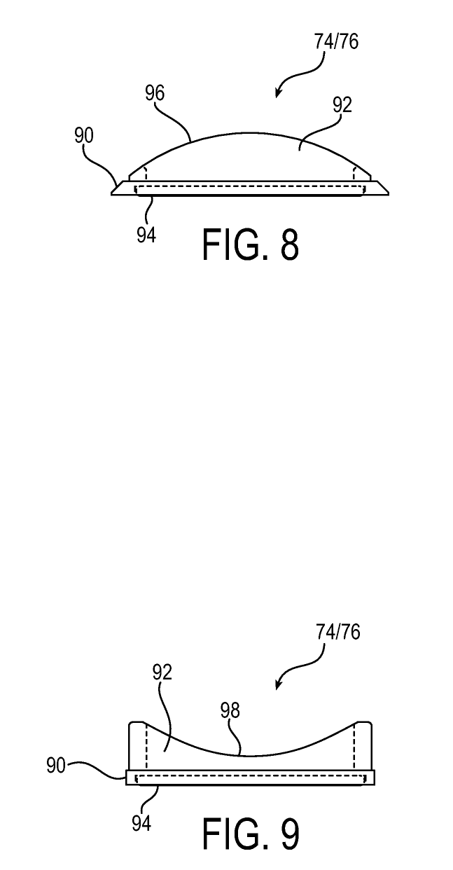

FIGS. 6-9 are drawings depicting various views of an exemplary sealing insert, which may be either the first sealing insert 74 or the second sealing insert 76, of the spool valve of FIG. 4 in accordance with embodiments of the present invention. In particular, FIG. 6 depicts an isometric top-side view of the exemplary sealing insert. FIG. 7 depicts an isometric bottom-side view of the sealing insert. FIG. 8 depicts a side view of the exemplary sealing insert from a convex side, and FIG. 9 depicts a side view of the exemplary sealing insert from a concave side.

Referring to FIGS. 6-9, the sealing inserts 74, 76 may be made of a semi-rigid, elastomeric, or otherwise suitable compressible or partially compressible material as are known in the art to be suitable for energized seals. In exemplary embodiments, the sealing inserts 74, 76 are made of Teflon® or a like material. Each sealing insert may include a base 90 and a raised cushion 92 that extends perpendicularly from the base 90. The base 90 may be shaped so as to be received within the correspondingly shaped pockets 80 and 82 of the spool body 72. The base of the sealing inserts may be adhered to or bonded to the pockets by any suitable means. Alternatively, the sealing inserts may be trapped within the pockets by compression of the cushion within the bore of the filter head, without any additional bonding or adhering composition.

The bottom of the cushion 92 (see the bottom view of FIG. 7) may include an annular ring that is configured to receive an additional compressible o-ring 94, which in operation can act as a spring to apply pressure on the cushion to aid the cushion in forming a seal. The o-ring thus is compressible to energize the sealing insert during operation. The cushion may have a generally rounded cross-section, such as a circular or ovular shape in cross-section, and the cushion may extend from the base to different heights along such cross-section. As seen in the figures, the cushion 92 may include convex portions 96 and concave portions 98 alternating along the cross-section. The shaping of the cushion in this manner provides for enhanced sealing when compressed within the bore of the filter head to prevent fluid flow into and out form ports in the filter head that are blocked by the sealing inserts. The seal provided by the sealing inserts also provides a secondary sealing function of between the spool valve body 72 and the bore in addition to the o-rings 64 shown in FIG. 3.

The spool valve 70 may operate as follows for controlling the flow of fluid within the filter assembly 10. In general, the sealing inserts and the porting are configured to control fluid flow through the spool valve into and out from the inlet and outlet fluid pathways in the filter head based on an alignment of the sealing inserts and the porting with the inlet and outlet fluid pathways corresponding to rotational positioning of the spool valve within the valve housing, thereby selectively controlling the fluid flow to and from the first filter and the second filter. For example, based on the rotational position of the spool valve, the spool valve is configured to block fluid flow to and from one of the first or second filter and permit fluid flow to and from the other of the first or second filters. The sealing inserts provide a seal against the valve housing to prevent leakage from the blocked filter. In this manner, one of the filters may be replaced while the other filter remains in operation, which avoids downtime of the system during filter replacement.

To achieve such operation, the inlet control ports of the spool valve are selectively alignable based on the rotational positional position of the spool valve with at least one of the first and second inlet fluid pathways of the valve housing to permit at least one of the first and second inlet flows. Similarly, the outlet control ports are selectively alignable based on the rotational positional position of the spool valve with at least one of the first and second outlet fluid pathways of the valve housing to permit at least one of the first and second outlet flows. The sealing inserts then are selectively alignable so as to block none of the flow so both filters are in operation, or to block flow to one or the other of the filters with the non-blocked filter remaining in operation. More particularly, the sealing inserts are selectively alignable based on the rotational positional position of the spool valve with either the first inlet and outlet fluid pathways of the valve housing, or the second inlet and outlet fluid pathways of the valve housing, respectively to block selectively either the first inlet and outlet flows of the first filter or the second inlet and outlet flows of the second filter.

Such operation is described as follows with reference to the figures. As referenced above, during operation of the filter assembly 10, the spool valve 32 is configured to operate as a three-way or three-position valve. A first rotational position corresponds to both filter components being in operation. Referring additionally to the inlet and outlet pathways shown in FIG. 3, in this first rotational position, the inlet control port 86b of the spool valve is in fluid communication with the main inlet port 40 of the filter head, and the outlet control port 88b of the spool valve is in fluid communication with the main outlet port 42 of the filter head. In such position, the inlet control port 86a of the spool valve is in fluid communication with the first inlet path 44 in the filter head to the first filter component 14, and the inlet control port 86c of the spool valve is in fluid communication with the second inlet path 52 in the filter head to the second filter component 16. As a result, an input flow can flow through the spool valve to both filter components. Similarly for the output flow, the outlet control port 88a of the spool valve is in fluid communication with the first outlet path 48 in the filter head from the first filter component 14, and the outlet control port 88c of the spool valve is in fluid communication with the second outlet path 56 in the filter head to the second filter component 16. As a result, an output flow can flow from both filter components through the spool valve. In this first position, the sealing inserts face downward away from the gauge and are not in fluid communication with any of the ports in the filter head 12.

A second rotational position corresponds to the first filter component 14 receiving flow and being in operation, and the second filter component 16 being blocked from fluid flow and isolated from the remainder of the system. In this second rotational position, the inlet control port 86c of the spool valve is in fluid communication with the main inlet port 40 of the filter head, and the outlet control port 88c of the spool valve is in fluid communication with the main outlet port 42 of the filter head. In such position, the inlet control port 86b of the spool valve is in fluid communication with the first inlet path 44 in the filter head to the first filter component 14, which permits an input flow into the first filter component. In the second position, however, the first sealing insert 72 blocks flow from entering the second inlet path 52 in the filter head to the second filter component 16. As a result, an input flow can flow through the spool valve to the first filter component 14, but not to the second filter component 16. Similarly for the output flow, the outlet control port 88b of the spool valve is in fluid communication with the first outlet path 48 in the filter head from the first filter component 14, but the second sealing insert 76 blocks flow from the from the second outlet path 56 in the filter head to the second filter component 16. As a result, an output flow can flow from the first filter component through the spool valve, but is blocked from the second filter component. In this second position, the ports 86a and 88a of the spool valve are not in fluid communication with any of the ports in the filter head 12.

A third rotational position corresponds to the second filter component 16 receiving flow and being in operation, and the first filter component 14 being blocked from fluid flow and isolated from the remainder of the system. In this third rotational position, the inlet control port 86a of the spool valve is in fluid communication with the main inlet port 40 of the filter head, and the outlet control port 88a of the spool valve is in fluid communication with the main outlet port 42 of the filter head. In such position, the inlet control port 86b of the spool valve is in fluid communication with the second inlet path 52 in the filter head to the second filter component 16, which permits an input flow into the second filter component. In the third position, however, the first sealing insert 72 blocks flow from entering the first inlet path 44 in the filter head to the first filter component 14. As a result, an input flow can flow through the spool valve to the second filter component 16, but not to the first filter component 14. Similarly for the output flow, the outlet control port 88b of the spool valve is in fluid communication with the second outlet path 56 in the filter head from the second filter component 16, but the second sealing insert 76 blocks flow from the from the second outlet path 48 in the filter head to the second first component 14. As a result, an output flow can flow from the second filter component through the spool valve, but is blocked from the first filter component. In this third position, the ports 86c and 88c of the spool valve are not in fluid communication with any of the ports in the filter head 12.

When blocking ports of the filter head 12, the sealing inserts 74 and 76 provide an enhanced seal as compared to conventional configurations. Accordingly, in the second or third positions, the blocked and isolated filter component can be replaced while the other filter component remains in operation, without any fluid leakage that has occurred in conventional configurations. The spool valve of the present invention, therefore, has advantages in avoiding cleanup costs associated with leakage, and reduces downtime insofar as the fluid system can remain in operation while one of the filter components is being replaced.

An aspect of the invention, therefore, is a spool valve. In exemplary embodiments, the spool valve includes a generally cylindrical spool body defining porting for control of a fluid flow through the spool body, the spool body having at least one pocket formed on an outer surface of the spool body, and at least one sealing insert received within the at least one pocket. The at least one sealing insert and the porting are configured to control fluid flow through the spool valve based on an alignment of the at least one sealing insert and the porting corresponding to rotational positioning of the spool valve within a valve housing. In exemplary embodiments, the spool valve may include one or more of the following features, either individually or in combination.

In an exemplary embodiment of the spool valve, the sealing insert comprises a base that is positioned against the pocket, and a raised cushion that extends perpendicularly from the base.

In an exemplary embodiment of the spool valve, a shape of the base of the sealing insert corresponds to a shape of the pocket.

In an exemplary embodiment of the spool valve, the cushion has a rounded cross-section and extends from the base to different heights along the cross-section.

In an exemplary embodiment of the spool valve, the cushion includes convex portions and concave portions that alternate along the cross-section of the cushion.

In an exemplary embodiment of the spool valve, the sealing insert has an annular groove and an o-ring received within the annular groove, wherein the o-ring is compressible to energize the sealing insert.

In an exemplary embodiment of the spool valve, the spool body comprises a first pocket and a second pocket formed on the outer surface of the spool body, and a first sealing insert received in the first pocket and a second sealing insert received in the second pocket.

In an exemplary embodiment of the spool valve, the porting comprises a plurality of inlet control ports configured to control an inlet flow through the spool valve, and a plurality of outlet control ports configured to control an outlet flow through the spool valve.

In an exemplary embodiment of the spool valve, the spool valve has a plurality of circumferential grooves formed on the outer surface, and a plurality of o-rings are received respectively in each of the plurality of circumferential grooves, wherein the o-rings are configured to form a seal between the spool body and the valve housing.

Another aspect of the invention is a valve head. In exemplary embodiments, the valve head includes a valve housing defining a bore, and a spool valve received within the bore, the spool valve comprising a generally cylindrical spool body defining porting for control of a fluid flow through the spool body, the spool body having at least one pocket formed on an outer surface of the spool body, and at least one sealing insert received within the at least one pocket. The valve housing further defines at least one inlet fluid pathway for an inlet flow and at least one outlet fluid pathway for an outlet flow of fluid through the valve housing. The at least one sealing insert and the porting are configured to control fluid flow through the spool valve into and out from the inlet and outlet fluid pathways in the valve housing based on an alignment of the at least one sealing insert and the porting with the inlet and outlet fluid pathways corresponding to rotational positioning of the spool valve within the valve housing. In exemplary embodiments, the valve head may include one or more of the following features, either individually or in combination.

In an exemplary embodiment of the valve head: the spool body comprises a first pocket and a second pocket formed on the outer surface of the spool body, and a first sealing insert received in the first pocket and a second sealing insert received in the second pocket; the porting defined by the spool body comprises a plurality of inlet control ports configured to control an inlet flow through the spool valve, and a plurality of outlet control ports configured to control an outlet flow through the spool valve; the inlet control ports are selectively alignable based on the rotational positional position of the spool valve with the at least one inlet fluid pathway of the valve housing to permit the inlet flow; the outlet control ports are selectively alignable based on the rotational positional position of the spool valve with the at least one outlet fluid pathway of the valve housing to permit the outlet flow; and the sealing inserts are selectively alignable based on the rotational positional position of the spool valve with the at least one inlet and the at least one outlet fluid pathways of the valve housing to block the inlet and outlet flows.

In an exemplary embodiment of the valve head: the valve housing defines a first inlet fluid pathway for a first inlet flow and a second inlet fluid pathway for a second inlet flow of fluid through the valve housing; the valve housing defines a first outlet fluid pathway for a first outlet flow and a second outlet pathway for a second outlet flow of fluid through the valve housing; the inlet control ports are selectively alignable based on the rotational positional position of the spool valve with at least one of the first and second inlet fluid pathways of the valve housing to permit at least one of the first and second inlet flows; the outlet control ports are selectively alignable based on the rotational positional position of the spool valve with at least one of the first and second outlet fluid pathways of the valve housing to permit at least one of the first and second outlet flows; and the sealing inserts are selectively alignable based on the rotational positional position of the spool valve with either the first inlet and outlet fluid pathways of the valve housing, or the second inlet and outlet fluid pathways of the valve housing, respectively to block selectively either the first inlet and outlet flows or the second inlet and outlet flows.

In an exemplary embodiment of the valve head, the sealing insert comprises a base that is positioned against the pocket, and a raised cushion that extends perpendicularly from the base.

In an exemplary embodiment of the valve head, a shape of the base of the sealing insert corresponds to a shape of the pocket.

In an exemplary embodiment of the valve head, the cushion includes convex portions and concave portions that alternate along a cross-section of the cushion.

In an exemplary embodiment of the valve head, the sealing insert has an annular groove and an o-ring received within the annular groove, wherein the o-ring is compressible to energize the sealing insert.

Another aspect of the invention s a filter assembly. In exemplary embodiments, the filter assembly includes a plurality of filters including at least a first filter and a second filter, a filter head configured to support the first filter and the second filter, the filter head comprising a valve housing defining a bore, and a spool valve received within the bore, the spool valve comprising a generally cylindrical spool body defining porting for control of a fluid flow through the spool body, the spool body having at least one pocket formed on an outer surface of the spool body, and at least one sealing insert received within the at least one pocket. The valve housing further defines inlet fluid pathways for an inlet flow through the valve housing to each of the first filter and the second filter, and outlet fluid pathways for an outlet flow of fluid through the valve housing from each of the first filter and the second filter. The at least one sealing insert and the porting are configured to control fluid flow through the spool valve into and out from the inlet and outlet fluid pathways in the filter head based on an alignment of the at least one sealing insert and the porting with the inlet and outlet fluid pathways corresponding to rotational positioning of the spool valve within the valve housing, thereby selectively controlling the fluid flow to and from the first filter and the second filter. In exemplary embodiments, the filter assembly may include one or more of the following features, either individually or in combination.

In an exemplary embodiment of the filter assembly, based on the rotational position of the spool valve, the spool valve is configured to block fluid flow to and from one of the first or second filter and permit fluid flow to and from the other of the first or second filters, the at least one sealing insert providing a seal against the valve housing to prevent leakage from the blocked filter.

In an exemplary embodiment of the filter assembly: the spool body comprises a first pocket and a second pocket formed on the outer surface of the spool body, and a first sealing insert received in the first pocket and a second sealing insert received in the second pocket; the porting defined by the spool body comprises a plurality of inlet control ports configured to control an inlet flow through the spool valve, and a plurality of outlet control ports configured to control an outlet flow through the spool valve; the valve housing defines a first inlet fluid pathway for a first inlet flow of fluid to the first filter and a second inlet fluid pathway for a second inlet flow of fluid to the second filter; the valve housing defines a first outlet fluid pathway for a first outlet flow of fluid from the first filter and a second outlet pathway for a second outlet flow of fluid from the second filter; the inlet control ports of the spool valve are selectively alignable based on the rotational positional position of the spool valve with at least one of the first and second inlet fluid pathways of the valve housing to permit at least one of the first and second inlet flows; the outlet control ports are selectively alignable based on the rotational positional position of the spool valve with at least one of the first and second outlet fluid pathways of the valve housing to permit at least one of the first and second outlet flows; and the sealing inserts are selectively alignable based on the rotational positional position of the spool valve with either the first inlet and outlet fluid pathways of the valve housing, or the second inlet and outlet fluid pathways of the valve housing, respectively to block selectively either the first inlet and outlet flows of the first filter or the second inlet and outlet flows of the second filter.

In an exemplary embodiment of the filter assembly, the sealing insert comprises a base that is positioned against the pocket, and a raised cushion that extends perpendicularly from the base.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A spool valve comprising:
a generally cylindrical spool body defining porting for control of a fluid flow through the spool body, the spool body having at least one pocket formed on an outer surface of the spool body; and
at least one sealing insert received within the at least one pocket;
wherein the at least one sealing insert and the porting are configured to control fluid flow through the spool valve based on an alignment of the at least one sealing insert and the porting corresponding to rotational positioning of the spool valve within a valve housing.

2. The spool valve of claim 1, wherein the sealing insert comprises a base that is positioned against the pocket, and a raised cushion that extends perpendicularly from the base.

3. The spool valve of claim 2, wherein a shape of the base of the sealing insert corresponds to a shape of the pocket.

4. The spool valve of claim 2, wherein the cushion has a rounded cross-section and extends from the base to different heights along the cross-section.

5. The spool valve of claim 5, wherein the cushion includes convex portions and concave portions that alternate along the cross-section of the cushion.

6. The spool valve of claim 1, wherein the sealing insert has an annular groove and an o-ring received within the annular groove, wherein the o-ring is compressible to energize the sealing insert.

7. The spool valve of claim 1, wherein:
the spool body comprises a first pocket and a second pocket formed on the outer surface of the spool body; and
a first sealing insert received in the first pocket and a second sealing insert received in the second pocket.

8. The spool valve of claim 1, wherein the porting comprises a plurality of inlet control ports configured to control an inlet flow through the spool valve, and a plurality of outlet control ports configured to control an outlet flow through the spool valve.

9. The spool valve of claim 1, wherein the spool valve has a plurality of circumferential grooves formed on the outer surface, and a plurality of o-rings are received respectively in each of the plurality of circumferential grooves, wherein the o-rings are configured to form a seal between the spool body and the valve housing.

10. A valve head comprising:
a valve housing defining a bore; and
a spool valve received within the bore, the spool valve comprising a generally cylindrical spool body defining porting for control of a fluid flow through the spool body, the spool body having at least one pocket formed on an outer surface of the spool body, and at least one sealing insert received within the at least one pocket;
the valve housing further defining at least one inlet fluid pathway for an inlet flow and at least one outlet fluid pathway for an outlet flow of fluid through the valve housing;
wherein the at least one sealing insert and the porting are configured to control fluid flow through the spool valve into and out from the inlet and outlet fluid pathways in the valve housing based on an alignment of the at least one sealing insert and the porting with the inlet and outlet fluid pathways corresponding to rotational positioning of the spool valve within the valve housing.

11. The valve head of claim 10, wherein:
the spool body comprises a first pocket and a second pocket formed on the outer surface of the spool body, and a first sealing insert received in the first pocket and a second sealing insert received in the second pocket;
the porting defined by the spool body comprises a plurality of inlet control ports configured to control an inlet flow through the spool valve, and a plurality of outlet control ports configured to control an outlet flow through the spool valve;
the inlet control ports are selectively alignable based on the rotational positional position of the spool valve with the at least one inlet fluid pathway of the valve housing to permit the inlet flow;
the outlet control ports are selectively alignable based on the rotational positional position of the spool valve with the at least one outlet fluid pathway of the valve housing to permit the outlet flow; and
the sealing inserts are selectively alignable based on the rotational positional position of the spool valve with the at least one inlet and the at least one outlet fluid pathways of the valve housing to block the inlet and outlet flows.

12. The valve head of claim 11, wherein:
the valve housing defines a first inlet fluid pathway for a first inlet flow and a second inlet fluid pathway for a second inlet flow of fluid through the valve housing;
the valve housing defines a first outlet fluid pathway for a first outlet flow and a second outlet pathway for a second outlet flow of fluid through the valve housing;
the inlet control ports are selectively alignable based on the rotational positional position of the spool valve with at least one of the first and second inlet fluid pathways of the valve housing to permit at least one of the first and second inlet flows;
the outlet control ports are selectively alignable based on the rotational positional position of the spool valve with at least one of the first and second outlet fluid pathways of the valve housing to permit at least one of the first and second outlet flows; and
the sealing inserts are selectively alignable based on the rotational positional position of the spool valve with either the first inlet and outlet fluid pathways of the valve housing, or the second inlet and outlet fluid pathways of the valve housing, respectively to block selectively either the first inlet and outlet flows or the second inlet and outlet flows.

13. The valve head of claim 10, wherein the sealing insert comprises a base that is positioned against the pocket, and a raised cushion that extends perpendicularly from the base.

14. The valve head of claim 13, wherein a shape of the base of the sealing insert corresponds to a shape of the pocket.

15. The valve head of claim 13, wherein the cushion includes convex portions and concave portions that alternate along a cross-section of the cushion.

16. The valve head of claim 10, wherein the sealing insert has an annular groove and an o-ring received within the annular groove, wherein the o-ring is compressible to energize the sealing insert.

17. A filter assembly comprising:
a plurality of filters including at least a first filter and a second filter;
a filter head configured to support the first filter and the second filter, the filter head comprising a valve housing defining a bore; and
a spool valve received within the bore, the spool valve comprising a generally cylindrical spool body defining porting for control of a fluid flow through the spool body, the spool body having at least one pocket formed on an outer surface of the spool body, and at least one sealing insert received within the at least one pocket;
the valve housing further defining inlet fluid pathways for an inlet flow through the valve housing to each of the first filter and the second filter, and outlet fluid pathways for an outlet flow of fluid through the valve housing from each of the first filter and the second filter;
wherein the at least one sealing insert and the porting are configured to control fluid flow through the spool valve into and out from the inlet and outlet fluid pathways in the filter head based on an alignment of the at least one sealing insert and the porting with the inlet and outlet fluid pathways corresponding to rotational positioning of the spool valve within the valve housing, thereby selectively controlling the fluid flow to and from the first filter and the second filter.

18. The filter assembly according to claim 17, wherein based on the rotational position of the spool valve, the spool valve is configured to block fluid flow to and from one of the first or second filter and permit fluid flow to and from the other of the first or second filters, the at least one sealing insert providing a seal against the valve housing to prevent leakage from the blocked filter.

19. The filter assembly of claim 17, wherein:
the spool body comprises a first pocket and a second pocket formed on the outer surface of the spool body, and a first sealing insert received in the first pocket and a second sealing insert received in the second pocket;
the porting defined by the spool body comprises a plurality of inlet control ports configured to control an inlet flow through the spool valve, and a plurality of outlet control ports configured to control an outlet flow through the spool valve;
the valve housing defines a first inlet fluid pathway for a first inlet flow of fluid to the first filter and a second inlet fluid pathway for a second inlet flow of fluid to the second filter;
the valve housing defines a first outlet fluid pathway for a first outlet flow of fluid from the first filter and a second outlet pathway for a second outlet flow of fluid from the second filter;
the inlet control ports of the spool valve are selectively alignable based on the rotational positional position of the spool valve with at least one of the first and second inlet fluid pathways of the valve housing to permit at least one of the first and second inlet flows;
the outlet control ports are selectively alignable based on the rotational positional position of the spool valve with at least one of the first and second outlet fluid pathways of the valve housing to permit at least one of the first and second outlet flows; and
the sealing inserts are selectively alignable based on the rotational positional position of the spool valve with either the first inlet and outlet fluid pathways of the valve housing, or the second inlet and outlet fluid pathways of the valve housing, respectively to block selectively either the first inlet and outlet flows of the first filter or the second inlet and outlet flows of the second filter.

20. The filter assembly of claim 17, wherein the sealing insert comprises a base that is positioned against the pocket, and a raised cushion that extends perpendicularly from the base.
